(19) United States
(12) Patent Application Publication
(10) Pub. No.: US 2024/0259411 A1
(43) Pub. Date: Aug. 1, 2024

(54) COMPUTER SYSTEM BEHAVIOR DETECTION

(71) Applicants: Scott Riley Terry, Murrieta, CA (US); Derek Myron Johnson, Temecula, CA (US); Stewart David Olson, San Diego, CA (US)

(72) Inventors: Scott Riley Terry, Murrieta, CA (US); Derek Myron Johnson, Temecula, CA (US); Stewart David Olson, San Diego, CA (US)

(21) Appl. No.: 18/424,723

(22) Filed: Jan. 26, 2024

Related U.S. Application Data
(60) Provisional application No. 63/441,440, filed on Jan. 26, 2023.

(51) Int. Cl. H04L 9/40

(52) U.S. Cl. CPC H04L 63/1425

(57) ABSTRACT

Computer-implemented computer system user behavior detection methods, systems, and computer-readable media are described.

### FIELD

Some implementations are generally related to computer system security and management, and, in particular, to computer system behavior detection and classification to identify potentially malicious behavior, among other things.

### BACKGROUND

Computer users, including human users, external computer system users, internal or external software users, or the like, typically exhibit patterns of behavior in terms of the user's interaction with a computer system. Behaviors can include ways in which users interact with a file system and cause file system operations to occur, or behaviors can include one or more file operations.

User behavior can be an indicator of the type of user or activity occurring. For example, ransomware attacks often involve a malicious program encrypting the files on a computer system and not unencrypting the files until a ransom is paid, hence the name ransomware. In order for the malicious user (e.g., a malicious program operating on the computer system) to perform the tasks necessary to take the files hostage, a certain pattern of file system operations must occur in a relatively short period of time. A need may exist for a system to be able to detect behavior such as a ransomware attack within a sufficiently short period of time so as to effectively stop the attack while suffering minimal file damage. Ransomware operations are just one example of the type of behavior that computer system operators would benefit from an ability to detect via file system operations.

For example, as mentioned above, ransomware rapidly encrypts a file system and blocks owners of data from accessing said data. This type of cyberattack is thought to be responsible for billions of dollars of annual losses for private and public organizations.

Conventional ransomware detection methods may rely on known file extensions and may not catch ransomware that uses novel file extensions. Conventional systems often leverage advanced learning techniques to identify patterns of behavior attributable to known types of ransomware but may miss variant types of ransomware behavior or other behaviors being monitored.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

FIG. 1 is a block diagram of an example system and a network environment which may be used for one or more implementations described herein.

FIG. 2 is a flowchart of an example method of computer behavior detection using Microsoft Windows Event Trace for Windows (ETW) system in accordance with some implementations.

FIG. 3 is a flowchart of an example method of computer behavior detection using system logs in accordance with some implementations.

FIG. 4 is a diagram showing an example behavior detection process in accordance with some implementations.

FIG. 5 is a diagram showing example layers and corresponding functions for behavior detection in accordance with some implementations.

FIG. 6 is a diagram of example behavior detection profiles in accordance with some implementations.

FIG. 7 is a block diagram of an example computing device which may be used for one or more implementations described herein.

### DETAILED DESCRIPTION

Some implementations can include process for rapidly detecting novel behavior, for example, ransomware behavior (or other behavior such as anomalous behavior) in a system before it successfully encrypts (or otherwise modifies) files in an entire file system. Some implementations described herein can work against ransomware that uses novel file extensions as well as known file extensions. It will be appreciated that ransomware behavior detection is used herein as a non-limiting example to illustrate the principles of the disclosed subject matter. Other types of behavior can be detected. An implementation can be configured to detect anomalous behavior or behavior that may affect intended functioning of a computer system.

As stated above, ransomware rapidly encrypts a file system and blocks owners of data from accessing said data. This cyber-attack type is thought to be responsible for billions of dollars of annual losses for private and public organizations. Some implementations of the disclosed subject matter solve this problem.

Some implementations permit software engineers to produce software capable of detecting ransomware before the ransomware can successfully encrypt a whole filesystem. This provides an opportunity for a software product to stop ransomware before users suffer major data loss. This drastically minimizes the risk of loss from ransomware, especially if an implementation is implemented with known mechanisms for stopping ransomware from running. Thus, some implementations permit creation of a variety of software applications that can help protect users from data loss, and from the financial loss of paying a ransom to hackers who use ransomware to extort payment from users.

The disclosed subject matter differs from what currently exists. For example, conventional methods of detecting behavior and stopping ransomware attacks often rely on known file extensions that have been used by ransomware in the past. This can leave systems exposed to novel ransomware which may use any file extension in its attack. Some implementations can provide a method to catch ransomware through behavior detection before the ransomware encrypts the whole file system and works regardless of the file extension(s) used by the ransomware attack.

Because hackers can change the file extensions they use at will, current detection methods can be powerless or limited to stop new ransomware until after the hackers have successfully used it against 1 or more parties. Detecting changing of file extensions isn't the only way this is more successful than other implementations. At the end of the day most alternative types of solutions look for specific patterns of behavior but omit certain types of generic activity. For instance, some ransomware will leverage a specific mechanism to encrypt their files with random file extensions. Others may look for ‘behaviors’ like exceeding a certain volume of file changes (like the present disclosure describes) but if the program is a ‘trusted program’ they will not block the activity or notify the user. A key differentiator of the disclosed subject matter is that an implementation can be agnostic as to the users, processes, or locations involved with a given behavior or set of behaviors; cases which appear violate a heuristic (e.g., volume of changes, etc.) will be flagged.

Some implementations work against ransomware that uses novel file extensions as well as known file extensions. Some conventional ransomware detection methods may rely on known file extensions and cannot detect the use of novel file extensions. Some implementations can help ensure that a system is safe against novel ransomware attacks.

Some implementations can be used to produce anti-virus software, anti-ransomware software, or a variety of software programs that detect behavior via programmatic analysis of file system events.

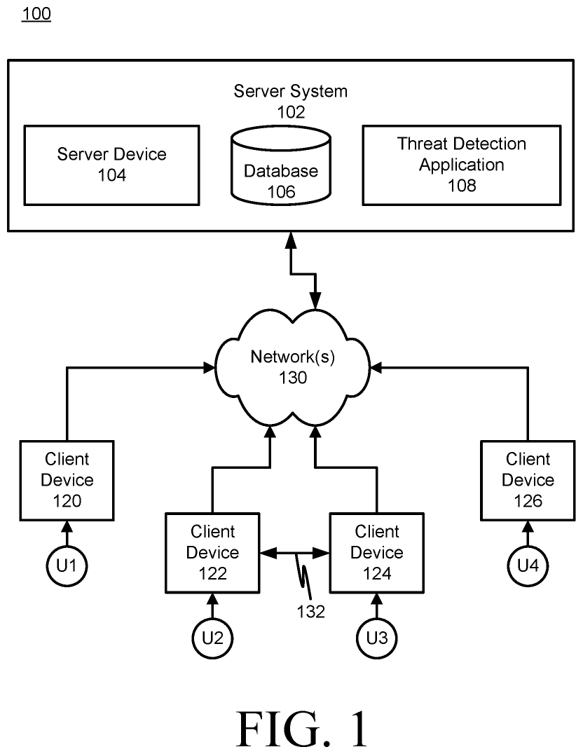

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104 and a database 106 or other data store or data storage device. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text video conferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide computer behavior detection functions as described herein.

Various implementations of features described herein can use any type of system and/or service. Any type of electronic device can make use of the features described herein. Some implementations can provide one or more features described herein on client or server devices disconnected from or intermittently connected to computer networks.

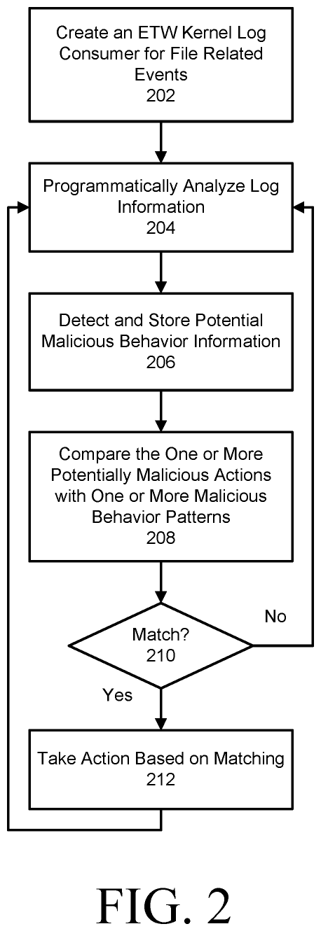

FIG. 2 is a flowchart of an example method of computer behavior detection using Microsoft ETW in accordance with some implementations. In particular, processing begins at 202, where an ETW kernel log consumer is created to consume ETW file related events. ETW can provide an advantage of providing information about file operations at a fast enough rate to be useful in helping stop malicious activity such as ransomware before the malicious code can do extensive damage. Processing continues to 204.

At 204, the log information is programmatically analyzed. In general, the file operation types, specifics of file operations, and the timing of the file operations can be programmatically analyzed. Processing continues to 206.

At 206, anomalous behavior information (e.g., potentially malicious behavior information) is detected and stored. Processing continues to 208.

At 208, the potentially anomalous behavior information is compared to one or more anomalous behavior patterns. For example, analysis of anomalous behavior information from the file logs can be based on a comparison of profiles as discussed in greater detail below. Processing continues to 210.

At 210, it is determined whether a match has occurred. If so, processing continues to 212. Otherwise, processing continues back to 204.

At 212, the system takes an action based on the matching.

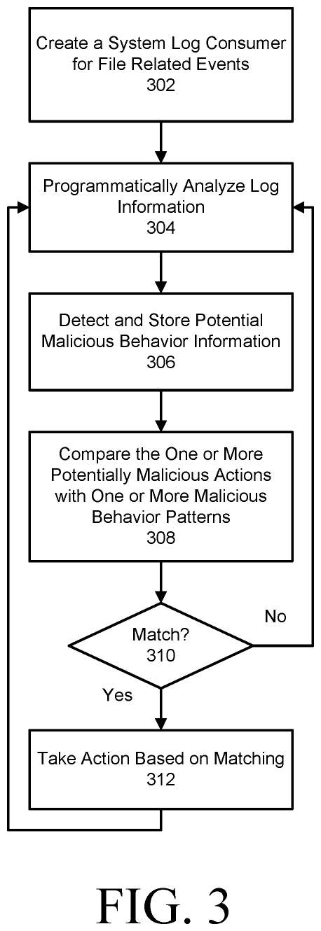

FIG. 3 is a flowchart of an example method of computer behavior detection using system log data in accordance with some implementations. In particular, processing begins at 302, where a system log consumer is created to consume file related event logs. Processing continues to 304.

At 304, the log information is programmatically analyzed. In general, the file operation types, file operations specifics, and the timing of the file operations can be programmatically analyzed. Processing continues 306.

At 306, anomalous behavior information (e.g., malicious behavior information) is detected and stored. Processing continues to 308.

At 308, the potentially anomalous behavior information is compared to one or more anomalous behavior patterns. For example, analysis of anomalous behavior information from the file logs can be based on a comparison of profiles as discussed in greater detail below. Processing continues to 310.

At 310, it is determined whether a match has occurred. If so, processing continues to 312. Otherwise, processing continues back to 304.

At 312, the system takes an action based on the matching.

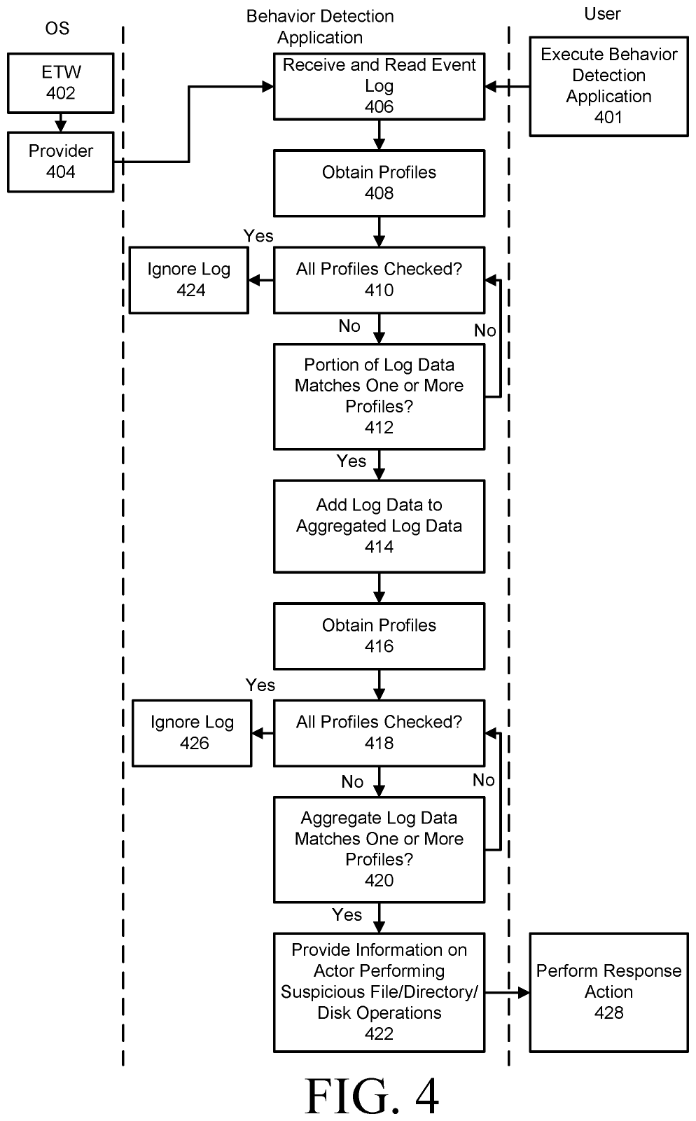

FIG. 4 is a diagram showing an example behavior detection process in accordance with some implementations. In particular, FIG. 4 shows the operations occurring in the operating system (OS), behavior detection application, and an authorized user (e.g., a system administrator). The authorized user executes a behavior detection process 401. On the operation system side, the ETW system 402 (or equivalent) gives system log data to a provider 404.

The behavior detection process then receives and reads the event log 406 and obtains profiles 408. A test is performed to determine if all profiles have been checked (e.g., compared against the log file data). If so, processing continues to 424 where the log is ignored. Otherwise, processing continues to 412, where the behavior detection process determines whether a portion (e.g., some or all) of the log data matches one or more profiles. Matching can include exact matching, partial matching, or matching within a given range or threshold. If there is a match, processing continues to 414, otherwise processing returns to 410.

At 414, the matching log data is added to an aggregate of log data. Processing continues to 416, where profiles are obtained (e.g., profiles for aggregate data). Processing continues to 418.

At 418, the behavior detection process determines if all aggregate profiles have been checked. If so, processing continues to 426, where the log data is ignored. Otherwise, processing continues to 420.

At 420, the behavior detection process determines whether the aggregate log data matches one or more aggregate profiles. If so, processing continues to 422. Otherwise, processing continues to 418.

At 422, information about the actor (or user) performing the matching activity such as suspicious file, directory or disk operations is provided to an external system or process, which can perform a response action 428.

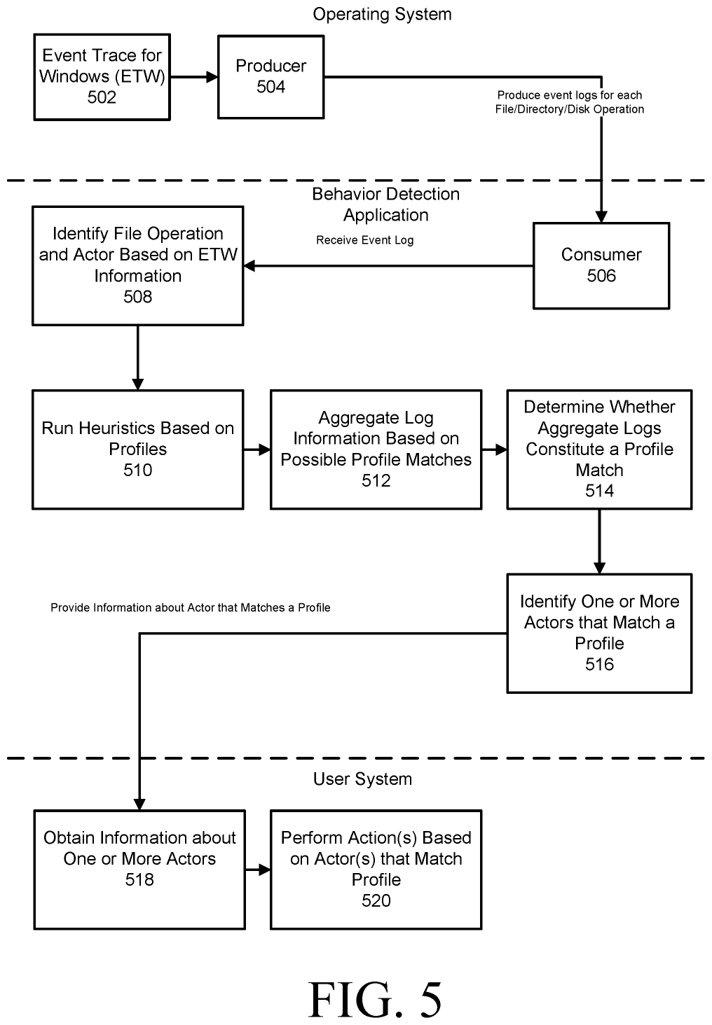

FIG. 5 is a diagram showing example layers and corresponding functions for behavior detection in accordance with some implementations. In particular, Microsoft Windows Event Trace for Windows (ETW) 502 provides system event data (e.g., for file, directory, or disk operations) to a log producer 504. The log producer 504 provides the log data to a log file consumer 506.

At 508, the behavior detection application or process identifies file operations and actors based on the ETW log information. At 510, heuristics are run based on profiles. At 512, information on possibly matching profiles is aggregated.

At 514, the behavior detection application or process determines whether the aggregated log information constitutes a profile match. The behavior detection application then identifies any actors that match a profile.

At 518, information about the actors matching a profile is obtained. At 520 one or more actions are performed on actors based on the matching profiles.

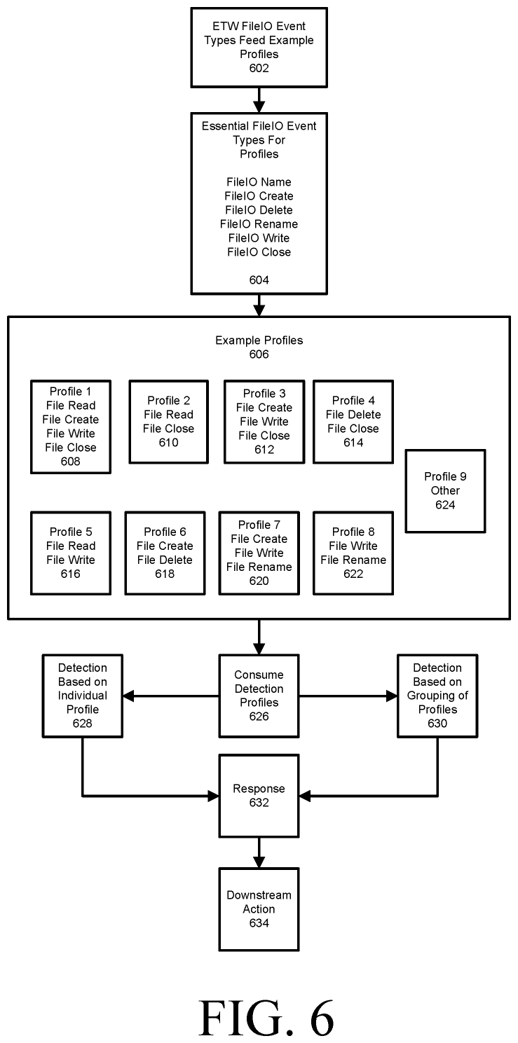

FIG. 6 is a diagram of example behavior detection profiles in accordance with some implementations. In particular, FIG. 6 shows feed example profiles 602 including ETW FileIO events. The ETW FileIO events 604 include events such as FileIO Name, FileIO Create, FileIO Delete, FileIO Rename, FileIO Write, and FileIO Close.

Example profiles are shown in block 606. It will be appreciated that an aspect of the profiles that is not shown is a timing aspect. For example, the behavior detection process may be looking for a given number of FileIO event profile matches within a given time period or range of time periods. For example, the time range can include 100 milliseconds to 5 seconds but can vary on either end according to a contemplated implementation of the disclosed subject matter.

The example profiles 606 include:
Profile 1 (608)—File Read, File Create, File Write, File Close.
Profile 2 (610)—File Read, File Close.
Profile 3 (612)—File Create, File Write, File Close.
Profile 4 (614)—File Delete, File Close.
Profile 5 (616)—File Read, File Write.
Profile 6 (618)—File Create, File Delete.
Profile 7 (620)—File Create, File Write, File Rename.
Profile 8 (622)—File Write, File Rename.
Profile 9 (624)—Other.

A detection profile consumer 626 obtains or accesses the detection profiles 606 and compares them to log data. There are two main types of behavior detection: detection based on individual profiles 628 and detection based on a grouping of two or more profiles or aggregate data from one or more log files 630. A response to the detection is determined at 632. Based on the determined response 632, a downstream action 634 is taken. Downstream actions can include, but are not limited to, alerting a system administrator, block the process or user associated with the detected behavior, moving the process or user associated with the detected behavior to an isolated system for further surveillance, etc.

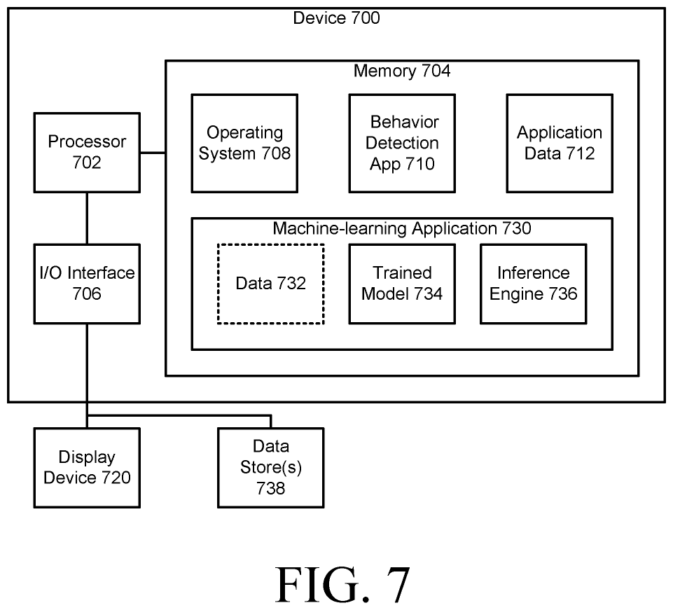

FIG. 7 is a block diagram of an example device 700 which may be used to implement one or more features described herein. In one example, device 700 can represent a client device, e.g., any of client devices 120-126 shown in FIG. 1. Alternatively, device 700 can implement a server device, e.g., server device 104, etc. In some implementations, device 700 may be used to implement a client device, a server device, or a combination of the above. Device 700 can be any suitable computer system, server, or other electronic or hardware device as described above.

One or more methods described herein (e.g., as shown in FIGS. 2-6) can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 700 includes a processor 702, a memory 704, and I/O interface 706. Processor 702 can be one or more processors and/or processing circuits to execute program code and control basic operations of the device 700. A “processor” includes any suitable hardware system, mechanism or component that processes data, signals or other information. A processor may include a system with a general-purpose central processing unit (CPU) with one or more cores (e.g., in a single-core, dual-core, or other multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 702 may include one or more co-processors that implement neural-network processing. In some implementations, processor 702 may be a processor that processes data to produce probabilistic output, e.g., the output produced by processor 702 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer can include any processor in communication with a memory.

Memory 704 is typically provided in device 700 for access by the processor 702 and may be any suitable processor-readable storage medium, such as random-access memory (RAM), read-only memory (ROM), Electrically Erasable Read-only Memory (EEPROM), Flash memory, etc., suitable for storing instructions for execution by the processor, and located separate from processor 702 and/or integrated therewith. Memory 704 can store software operating on the server device 700 by the processor 702, including an operating system 708, machine-learning application 730, computer behavior detection application 710, and application data 712. Other applications may include applications such as a data display engine, web hosting engine, image display engine, notification engine, social networking engine, etc. In some implementations, the machine-learning application 730 and computer user behavior detection application 710 can each include instructions that enable processor 702 to perform functions described herein, e.g., some or all of the methods of FIGS. 2-6.

The machine-learning application 730 can include one or more NER implementations for which supervised and/or unsupervised learning can be used. The machine learning models can include multi-task learning based models, residual task bidirectional LSTM (long short-term memory) with conditional random fields, statistical NER, etc. The Device can also include a computer user behavior detection application 710 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 730 may utilize Bayesian classifiers, support vector machines, neural networks, or other learning techniques. In some implementations, machine-learning application 730 may include a trained model 734, an inference engine 736, and data 732. In some implementations, data 732 may include training data, e.g., data used to generate trained model 734. For example, training data may include any type of data suitable for training a model for behavior detection tasks, such as profiles, labels, thresholds, etc. associated with behavior detection as described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 734, training data may include such user data. In implementations where users permit use of their respective user data, data 732 may include permitted data.

In some implementations, data 732 may include collected data such as computer user behavior data. In some implementations, training data may include synthetic data generated for the purpose of training, such as data that is not based on user input or activity in the context that is being trained, e.g., data generated from simulated conversations, computer-generated images, etc. In some implementations, machine-learning application 730 excludes data 732. For example, in these implementations, the trained model 734 may be generated, e.g., on a different device, and be provided as part of machine-learning application 730. In various implementations, the trained model 734 may be provided as a data file that includes a model structure or form, and associated weights. Inference engine 736 may read the data file for trained model 734 and implement a neural network with node connectivity, layers, and weights based on the model structure or form specified in trained model 734.

Machine-learning application 730 also includes a trained model 734. In some implementations, the trained model 734 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 732 or application data 712. Such data can include, for example, images, e.g., when the trained model is used for behavior detection functions. Subsequent intermediate layers may receive as input output of nodes of a previous layer per the connectivity specified in the model form or structure. These layers may also be referred to as hidden layers. A final layer (e.g., output layer) produces an output of the machine-learning application. For example, the output may be a set of labels for behavior data, an indication that given computer user behavior is anomalous, etc. depending on the specific trained model. In some implementations, model form or structure also specifies a number and/or type of nodes in each layer.

In different implementations, the trained model 734 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 734 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 732, to produce a result.

For example, training may include applying supervised learning techniques. In supervised learning, the training data can include a plurality of inputs (e.g., a set of images) and a corresponding expected output for each input (e.g., one or more labels for each image representing aspects of a project corresponding to the images such as services or products needed or recommended). Based on a comparison of the output of the model with the expected output, values of the weights are automatically adjusted, e.g., in a manner that increases the probability that the model produces the expected output when provided similar input.

In some implementations, training may include applying unsupervised learning techniques. In unsupervised learning, only input data may be provided, and the model may be trained to differentiate data, e.g., to cluster input data into a plurality of groups, where each group includes input data that are similar in some manner. For example, the model may be trained to identify anomalous computer user behavior associated with file system operations or operating system operations and/or select thresholds.

In another example, a model trained using unsupervised learning may cluster words based on the use of the words in data sources. In some implementations, unsupervised learning may be used to produce knowledge representations, e.g., that may be used by machine-learning application 730. In various implementations, a trained model includes a set of weights, or embeddings, corresponding to the model structure. In implementations where data 732 is omitted, machine-learning application 730 may include trained model 734 that is based on prior training, e.g., by a developer of the machine-learning application 730, by a third-party, etc. In some implementations, trained model 734 may include a set of weights that are fixed, e.g., downloaded from a server that provides the weights.

Machine-learning application 730 also includes an inference engine 736. Inference engine 736 is configured to apply the trained model 734 to data, such as application data 712, to provide an inference. In some implementations, inference engine 736 may include software code to be executed by processor 702. In some implementations, inference engine 736 may specify circuit configuration (e.g., for a programmable processor, for a field programmable gate array (FPGA), etc.) enabling processor 702 to apply the trained model. In some implementations, inference engine 736 may include software instructions, hardware instructions, or a combination. In some implementations, inference engine 736 may offer an application programming interface (API) that can be used by operating system 708 and/or computer user behavior detection application 710 to invoke inference engine 736, e.g., to apply trained model 734 to application data 712 to generate an inference.

Machine-learning application 730 may provide several technical advantages. For example, when trained model 734 is generated based on unsupervised learning, trained model 734 can be applied by inference engine 736 to produce knowledge representations (e.g., numeric representations) from input data, e.g., application data 712. For example, a model trained for behavior detection tasks may produce predictions and confidences for given input information about given computer user behavior. A model trained for behavior detection tasks may produce a prediction about whether given behavior is anomalous based on input behavior data (e.g., file system operations or the like) or other information. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 736.

In some implementations, knowledge representations generated by machine-learning application 730 may be provided to a different device that conducts further processing, e.g., over a network. In such implementations, providing the knowledge representations rather than the images may provide a technical benefit, e.g., enable faster data transmission with reduced cost. In another example, a model trained for computer user behavior detection may produce an anomalous behavior signal for computer user behavior data being processed by the model.

In some implementations, machine-learning application 730 may be implemented in an offline manner. In these implementations, trained model 734 may be generated in a first stage and provided as part of machine-learning application 730. In some implementations, machine-learning application 730 may be implemented in an online manner. For example, in such implementations, an application that invokes machine-learning application 730 (e.g., operating system 708, one or more of computer user behavior detection application 710 or other applications) may utilize an inference produced by machine-learning application 730, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 734, e.g., to update embeddings for trained model 734.

In some implementations, machine-learning application 730 may be implemented in a manner that can adapt to particular configuration of device 700 on which the machine-learning application 730 is executed. For example, machine-learning application 730 may determine a computational graph that utilizes available computational resources, e.g., processor 702. For example, if machine-learning application 730 is implemented as a distributed application on multiple devices, machine-learning application 730 may determine computations to be carried out on individual devices in a manner that optimizes computation. In another example, machine-learning application 730 may determine that processor 702 includes a GPU with a particular number of GPU cores (e.g., 1000) and implement the inference engine accordingly (e.g., as 1000 individual processes or threads).

In some implementations, machine-learning application 730 may implement an ensemble of trained models. For example, trained model 734 may include a plurality of trained models that are each applicable to the same input data. In these implementations, machine-learning application 730 may choose a particular trained model, e.g., based on available computational resources, success rate with prior inferences, etc. In some implementations, machine-learning application 730 may execute inference engine 736 such that a plurality of trained models is applied. In these implementations, machine-learning application 730 may combine outputs from applying individual models, e.g., using a voting-technique that scores individual outputs from applying each trained model, or by choosing one or more particular outputs. Further, in these implementations, machine-learning applications may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 708 or one or more other applications, e.g., computer user behavior detection application 710.

In different implementations, machine-learning application 730 can produce different types of outputs. For example, machine-learning application 730 can provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 730 may produce an output video with a particular effect applied, e.g., rendered in a comic-book or particular artist's style, when trained model 734 is trained using training data from the comic book or particular artist, etc. In some implementations, machine-learning application 730 may produce an output based on a format specified by an invoking application, e.g., operating system 708 or one or more applications, e.g., computer behavior detection application 710. In some implementations, an invoking application may be another machine-learning application. For example, such configurations may be used in generative adversarial networks, where an invoking machine-learning application is trained using output from machine-learning application 730 and vice-versa.

Any of software in memory 704 can alternatively be stored on any other suitable storage location or computer-readable medium. In addition, memory 704 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 704 and any other type of storage (magnetic disk, optical disk, magnetic tape, or other tangible media) can be considered “storage” or “storage devices.”

I/O interface 706 can provide functions to enable interfacing the server device 700 with other systems and devices. Interfaced devices can be included as part of the device 400 or can be separate and communicate with the device 700. For example, network communication devices, storage devices (e.g., memory and/or database 106), and input/output devices can communicate via I/O interface 706. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 706 can include one or more display devices 720 and one or more data stores 738 (as discussed above). The display devices 720 that can be used to display content, e.g., a user interface of an output application as described herein. Display device 720 can be connected to device 400 via local connections (e.g., display bus) and/or via networked connections and can be any suitable display device. Display device 720 can include any suitable display device such as an LCD, LED, or plasma display screen, CRT, television, monitor, touchscreen, 3-D display screen, or other visual display device. For example, display device 720 can be a flat display screen provided on a mobile device, multiple display screens provided in a goggles or headset device, or a monitor screen for a computer device.

The I/O interface 706 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 7 shows one block for each of processor 702, memory 704, I/O interface 706, and software blocks 708, 710, and 730. These blocks may represent one or more processors or processing circuitries, operating systems, memories, I/O interfaces, applications, and/or software modules. In other implementations, device 700 may not have all of the components shown and/or may have other elements including other types of elements instead of, or in addition to, those shown herein. While some components are described as performing blocks and operations as described in some implementations herein, any suitable component or combination of components of environment 100, device 700, similar systems, or any suitable processor or processors associated with such a system, may perform the blocks and operations described.

In some implementations, the computer user behavior detection system could include a machine-learning model (as described herein) for tuning the system (e.g., selecting behavior detection labels and corresponding thresholds) to potentially provide improved accuracy. Inputs to the machine learning model can include ICA labels, an image descriptor vector that describes appearance and includes semantic information about computer user behavior profiles. Example machine-learning model input can include labels for a simple implementation and can be augmented with descriptor vector features for a more advanced implementation. Output of the machine-learning module can include a prediction of whether a given pattern of computer user behavior is anomalous, malicious, or in some way warrants some further analysis or action.

One or more methods described herein (e.g., methods in FIGS. 2-6) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer implemented method comprising:
creating an ETW kernel log consumer configured to consume ETW file related events;
programmatically analyzing log information;
detecting potentially anomalous behavior information;
comparing the potentially anomalous behavior information to one or more anomalous behavior patterns;
determining whether a match has occurred; and
performing an action based on the determining.
